(19) United States
(12) Patent Application Publication
(10) Pub. No.: US 2007/0117670 A1
(43) Pub. Date: May 24, 2007

(54) Arrangement for variable drive of vehicle wheels

(75) Inventor: Carsten Buender, Gifthorn (DE)

Correspondence Address: CROWELL & MORING LLP;INTELLECTUAL PROPERTY GROUP, P.O. BOX 14300, WASHINGTON, DC, 20044-4300, US

(73) Assignee: hofer Getriebetechnik GmbH, Wolfsburg (DE)

(21) Appl. No.: 11/601,633

(22) Filed: Nov. 20, 2006

(30) Foreign Application Priority Data
Nov. 19, 2005 (DE) 10 2005 055 202.1

(51) Int. Cl. F16H 47/04

(52) U.S. Cl. 475/78; 475/83

(57) ABSTRACT

An arrangement for variable drive of the wheels of an axle of a motor vehicle includes a control device for influencing the drive torque on the wheels. The control device comprises a mechanical control element and a hydrostatic control element, which cooperate to allocate a defined drive torque to a particular wheel of the motor vehicle.

### BACKGROUND AND SUMMARY OF THE INVENTION

This application claims the priority of German patent document 10 2005 055 202.1, filed Nov. 19, 2005, the disclosure of which is expressly incorporated by reference herein.

The present invention relates to an arrangement for variable drive of the wheels of an axle of a motor vehicle.

Measures for preventing lateral breakaway of a motor vehicle during steering procedures by means of an electronic stability program (ESP) are known. Such highly effective stability programs, which are also referred to as vehicle dynamics control or VDC, utilize the vehicle's braking and drive systems. In particular, they combine the following the motor vehicle partial systems: antilock braking system (ABS), traction control system (TCS), engine drag-torque controller (MSR), automatic braking-force distribution (ABD), and yaw-moment control (YMC).

One difficulty with such systems is that kinetic energy is consumed during operation of the electronic stability program, which may be undesirable under defined vehicle-dynamic situations of the motor vehicle. The Swiss magazine Automob. Rev. 99 (2004) 35, page 15, describes a drive system for a motor vehicle in which a control arrangement is provided in a first axle having a differential and wheels. The control arrangement increases the drive torque on one wheel of the first axle as a function of steering angles on a second axle. Arrangements of this type are also known in connection with the English terms active yaw and torque vectoring.

German patent document DE 693 01 434 T2 discloses a device for distributing drive torque to the left and right sides of a vehicle, which includes a differential and a distributor unit having a first friction clutch and a second friction clutch. The distributor unit allocates the drive torque to the wheel of the left wheel axle and/or the wheel of the right wheel axle.

Another device for distributing the drive torque to the left wheel axle and the right wheel axle is also discussed in German patent document DE 693 04 144 T2.

One object of the present invention is to provide an arrangement for variable drive of an axle of a motor vehicle, in which a control device distributes drive torques to the wheels of this axle in a targeted way, and with proper function.

A primary advantage of the present invention is that, using the control device, which comprises a mechanical control element and a hydrostatic control element, a drive torque is allocated to a wheel of the axle in a defined way and with proper function.

According to the invention, the mechanical control element is formed by a planetary gear unit having two stages, for example, which has tested advantages for use in the control device. The same also can be said for the hydrostatic control element, which is implemented as a swashplate pump, whose technical properties are highly suitable for use in the control device. Although they are of different constructions, the planetary gear unit and the swashplate pump may be combined to form the control device at an acceptable outlay. The individual pumps of the swashplate pump may be installed either inside the planetary gears or revolving outside the latter, without problems. The drive torque for the particular wheel may be controlled by adjusting the stroke of the swashplate of the swashplate pump. However, it is also possible to use a disk cam which serves as a throttle for hydraulic medium by which the pumps of the swashplate pump are influenced. In addition, it is possible to integrate the complete control unit in a wheel drive axle without further measures.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic plan view of a drive of the rear axle of a motor vehicle having the arrangement according to the present invention, comprising a control device;

FIG. 2 shows a detail of FIG. 1 in larger scale;

FIG. 3 is a perspective view of the control device having multiple details;

FIG. 4 is a further perspective view of the control device, in connection with a differential of the rear axle; and

FIG. 5 is a perspective view of a disk cam of the control device.

### DETAILED DESCRIPTION OF THE DRAWINGS

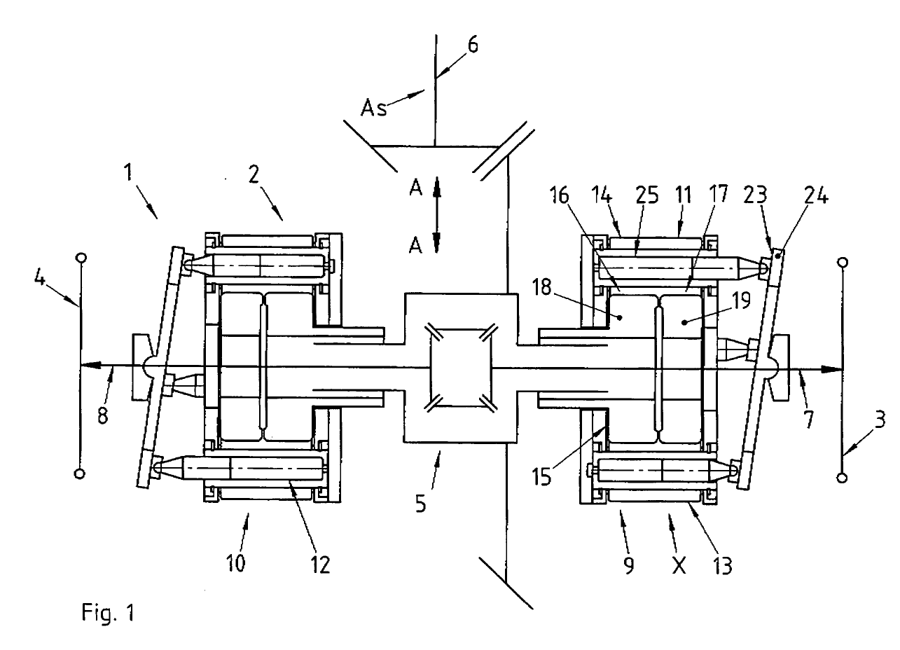

FIG. 1 shows schematically only a rear axle 2 having a right wheel 3 and a left wheel 4 in a motor vehicle 1 which has all-wheel-drive, such as disclosed for example, in German patent document DE 693 01 434 T2, referred to previously. A differential 5, which is a component of a drive system As (not shown) and is operationally linked to an input shaft 6 running in vehicle longitudinal direction A-A, for example, and to partial drive axles 7 and 8, is integrated in the rear axle 2.

Arrangements 9 and 10, by which the wheels 3 and 4 are variably drivable, are integrated in both partial drive axles 7 and 8. Control devices 11 and 12 which influence the drive torque on the wheels 3 and 4, are provided for this purpose. Each control device 11 comprises both a mechanical control element 13 and a hydrostatic control element 14, which work together in such a way that a defined drive torque is allocated to the wheel 3 associated with the partial drive axle 7.

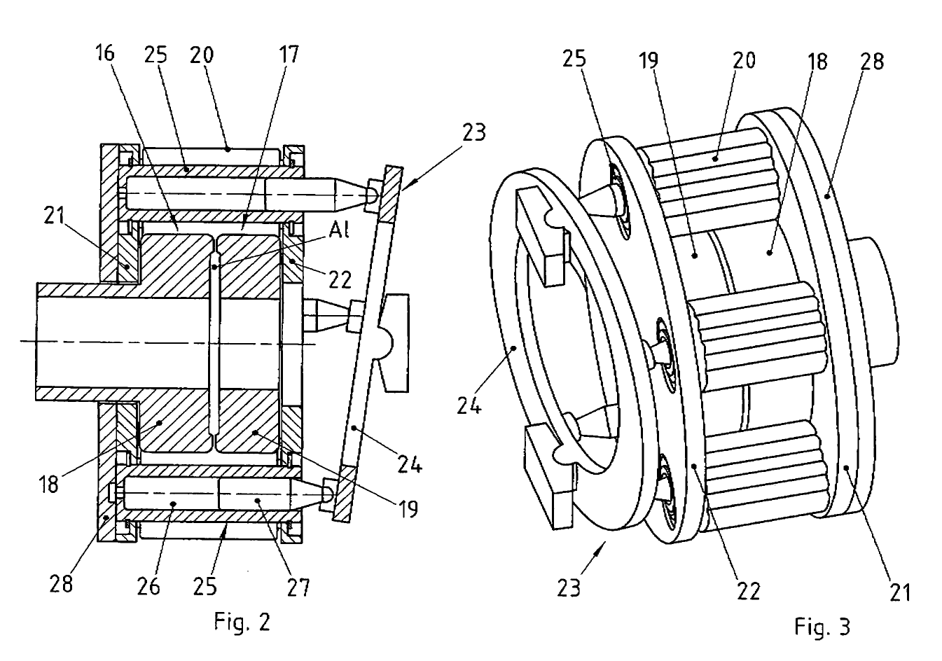

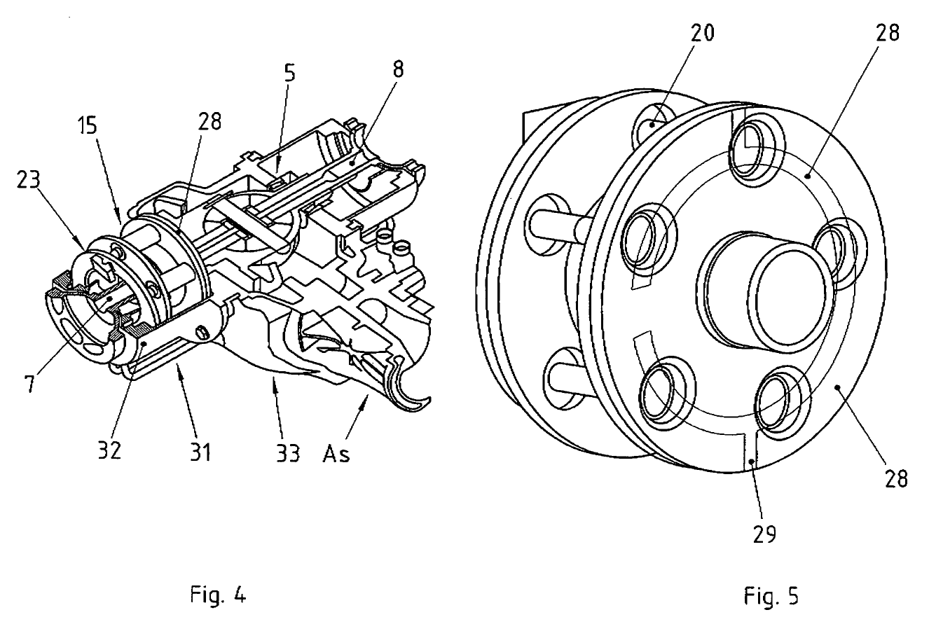

The mechanical control element 13 comprises a multistage planetary gear unit 15, which has two stages, namely a first stage 16 and a second stage 17, in the exemplary embodiment. In addition, the planetary gear unit 15 has two sun wheels 18 and 19, adjoining one another with mediation of an axial bearing Al (FIG. 2), which engage with five adjoining planet wheels 20 for example. The latter are situated between planet carriers 21 and 22.

The hydrostatic control element 14 is implemented as a swashplate pump 23, which works together with the planetary gear unit 15. The planetary gear unit 15 and the swashplate pump 23 are situated coaxially to one another, between the differential 5 and the wheel 3 of the partial drive axle 7. The swashplate pump 23 has a swashplate 24 and preferably five pumps 25, each of which is provided with a cylinder 26 and a piston 27 (FIG. 2).

The pumps 25 of the swashplate pump 23 are situated in such a way that they are enclosed by the planet wheels 20. However, it is also possible to locate these pumps 25 outside the planet wheels 20 and/or revolving between neighboring planet wheels.

The stroke of the swashplate 24 of the swashplate pump 23 is changed for defined control of the drive torque for the wheel 3 according to a first embodiment. A hydraulic or mechanical actuator, which may be represented by a spindle drive, is suitable for this purpose. In a second embodiment, the drive torque for the wheel is allocated with mediation of a throttle for a hydraulic medium. This throttle may be represented by a disk cam 28 having pressure channels 29 and suction channels 30. The disk cam 28 operates together with the pumps 25 of the swashplate pump 23 and is placed near the planet carriers 21 of the planetary gear unit 15, so that the cited disk cam 28 is situated coaxially to the planetary gear unit 15.

The disk cam 28, the planetary gear unit 15, and the swashplate pump 23 are assembled to form a module 31, which is housed in a receptacle housing 32. The receptacle housing 32 is interlocked with a bearing housing 33 of the drive system As, which encloses the differential 5.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An arrangement for variable drive of wheels of an axle of a motor vehicle, said arrangement comprising a control device for influencing the drive torque on the wheels, wherein:
the control device comprises a mechanical control element and a hydrostatic control element; and
the mechanical control element and the hydrostatic control element work together to allocate a defined drive torque to a particular wheel of the motor vehicle.

2. The arrangement according to claim 1, wherein the mechanical control element is formed by a planetary gear unit.

3. The arrangement according to claim 2, wherein the planetary gear unit has multiple stages.

4. The arrangement according to claim 2, wherein the planetary gear unit is provided with two adjoining sun wheels, which engage with shared planet wheels.

5. The arrangement according to claim 4, wherein the planet wheels are mounted between planet carriers which are spaced apart.

6. The arrangement according to claim 1, wherein the hydrostatic control element is formed by a swashplate pump, working together with the planetary gear unit, having pumps situated like planets and a swashplate, each pump comprising a cylinder and a piston.

7. The arrangement according to claim 1, wherein the planetary gear unit and the swashplate pump are situated coaxially to one another.

8. The arrangement according to claim 7, wherein the planetary gear unit and the swashplate pump are situated between a differential of the drive system and the wheel of the motor vehicle.

9. The arrangement according to claim 6, wherein the pumps of the swashplate pump are enclosed by the planet wheels.

10. The arrangement according to claim 6, wherein the pumps of the swashplate pump extend outside the planet wheels and revolve with the cited planet wheels.

11. The arrangement according to claim 1, wherein the drive torque for the particular wheel is controlled by adjusting the stroke via the swashplate.

12. The arrangement according to claim 11, wherein the inclination of the swashplate is set with mediation of an actuator, such as a spindle drive.

13. The arrangement according to claim 1, wherein control of the drive torque for the particular wheel is caused by a disk cam, implemented as a throttle, which influences the pumps.

14. The arrangement according to claim 1, wherein the disk cam is situated coaxially to one of the planetary gear unit and the swashplate pump.

15. The arrangement according to claim 1, wherein the disk cam, the planetary gear unit, and the swashplate pump are assembled to form a module in a receptacle housing.

16. The arrangement according to claim 15, wherein the receptacle housing is interlocked with a bearing housing of the drive system.
